(19) United States
(12) Patent Application Publication
(10) Pub. No.: US 2015/0185900 A1
(43) Pub. Date: Jul. 2, 2015

(54) MUTUAL CAPACITANCE TOUCH PANEL AND LIQUID CRYSTAL DISPLAY DEVICE

(71) Applicant: Shenzhen China Star Optoelectronics Technology Co. Ltd, Shenzhen Guangdong (CN)

(72) Inventor: Chengliang Ye, Shenzhen (CN)

(73) Assignee: Shenzhen China Star Optoelectronics Technology Co. Ltd, Shenzhen Guangdong (CN)

(21) Appl. No.: 14/235,346

(22) PCT Filed: Jan. 9, 2014
(86) PCT No.: PCT/CN2014/070379

§ 371 Date: Jan. 27, 2014

(30) Foreign Application Priority Data
Dec. 31, 2013 (CN) 201310752512.9

(51) Int. Cl. G06F 3/044; G02F 1/1335; G06F 1/16; G02F 1/1333

(52) U.S. Cl. CPC G06F 3/044; G02F 1/13338; G02F 1/1336; G06F 1/16; G06F 2203/04111

(57) ABSTRACT

A mutual capacitance touch panel is disclosed, comprising: a plurality of driving electrode strings arranged in parallel and along a horizontal direction, each driving electrode string includes multiple driving electrodes connected in series, each driving electrode connected with a driving electrode lead; and a plurality of sensor electrode strings arranged in parallel and along a vertical direction, each sensor electrode string includes multiple sensor electrodes connected in series, each sensor electrode connected with a sensor electrode lead; wherein, the electrodes are located on a same plane, and are distributed alternately with each other; between the adjacent driving electrode and the sensor electrode provided with a fill pattern; wherein, all fill patterns along a same horizontal direction, widths of the fill patterns are decreased gradually in an arithmetic way according to a direction away from the driving electrode lead.

### BACKGROUND OF THE INVENTION

1. Field of the Invention

The present invention relates to the technology field of touch panel, and more particularly to a mutual capacitance touch panel and a liquid crystal display device comprising the touch panel.

2. Description of Related Art

Touch display device as an input medium, is the most simple and convenient way of the human-computer interaction, so that the touch display device increasingly applied to a variety of electronic products. Wherein, the capacitive touch display device has advantages of long life, high transmittance, and capable of supporting multi-touch such that it becomes the mainstream of the touch display technology.

In the capacitive touch display device, it includes a capacitive touch panel. The capacitive touch panel includes a surface capacitive type and a projected capacitive type, wherein, the projected capacitive type can be divided into a self-capacitance type and a mutual capacitance type. The self-capacitance type fabricates a driving electrode array and a sensor electrode array on the glass surface using indium tin oxide (ITO, a transparent conductive material). The driving electrodes and sensor electrodes respectively form capacitors with the ground, and the capacitors are so called the self-capacitor, also known as the electrode-to-ground capacitor.

When a finger touches the capacitive screen, the capacitor of the finger will be superimposed on the screen capacitor, so that the capacitance of the screen capacitor will increase. In a touch inspection, the capacitive screen respectively inspects the driving electrode array and sensor electrode array sequentially, and based on the change amount of the capacitance before and after touching to respectively determine the coordinates of the driving electrode array and the sensor electrode array. Then, it combines into the touch coordinate of the plane.

The scanning method of the self-capacitance is equal to project the touch point on the touch screen to the directions of the X axis and Y axis, and respectively calculate it's coordinates at the X axis and Y axis. Finally, they are combined to form the coordinate of the touch point. The operation principle of touch method of the mutual capacitance type is shown in FIG. 1a. The mutual capacitance type also fabricates the driving electrode 101 and sensor electrode 201, and the cross location of the two electrodes form a coupling capacitor, that is, the two electrodes respectively form two terminals of the coupling capacitor. As shown in FIG. 1b, when the finger touch the capacitive screen, it affects the coupling of the two electrodes near the touching point in order to change the value of the coupling capacitor between the two electrodes. When detecting the value of the mutual capacitance, the sensor electrode sends a excitation signal, and scanning the electrode to receive the signal one by one such that it can obtain all capacitances at the cross locations of the driving electrode and the sensor electrode, that is, the capacitances of two dimension plane of whole touch screen. According to the change of the capacitances of two dimension plane of whole touch screen, it can calculate the coordinate of every touch point. Therefore, even though there are multiple touch points on the touch screen, it can calculate the true coordinate of each touch point.

The existing touch structure layer of the mutual capacitance touch panel is shown in FIG. 2 and FIG. 3. The touch structure layer comprises a plurality of driving electrode strings 10 arranged in parallel in the horizontal direction, and a plurality of sensor electrode strings 20 arranged in parallel in the vertical direction. Each of the driving electrode strings 10 comprises multiple driving electrodes 101 connected in series. Each of the driving electrode strings 10 connects to the control unit through the driving electrode lead 102. Each of the sensor electrode strings 20 comprises multiple sensor electrodes 201 connected in series. Each of the sensor electrode strings 20 connects to the control unit through the sensor electrode lead 202.

The driving electrode 101 and the sensor electrode 201 are disposed on the same plane to form a monolayer ITO mutual capacitance touch panel, i.e., the single layer ITO touch panel, referred as SITO. Wherein, the driving electrode 101 and the sensor electrode 201 are all rhombus shapes (the upper edges form a triangular shape). On the whole touch structure layer, the driving electrode 101 and the sensor electrode 201 are distributed alternately with each other, i.e., four sides of each of the driving electrodes 101 are all correspondingly provided with the sensor electrodes 201. At the same time, four sides of each of the sensor electrodes 201 are all correspondingly provided with the driving electrodes 101.

In the prior art, as shown in FIGS. 4 and 5, in order to increase the change amount of the mutual capacitance when the finger is touching to provide sensitivity for the touch panel, it is usually provided with a fill pattern 30 (dummy pattern) between the driving electrode 101 and the sensor electrode 201. As the schematic diagram shown in FIG. 6, after disposing the fill pattern 30 between the driving electrode 101 and the sensor electrode 201, it increases the change amount of the mutual capacitance when the finger touches the touch panel. However, in the conventional art, the size of all fill pattern 30 are the same, and when the screen area is larger, the locations of each driving electrode string 10 which are away from the driving electrode lead 102, the resistance and capacitance are relatively large and the change amount when touching is small as the curve shown in FIG. 7. In FIG. 7, the sensing variation in the vertical coordinate indicates the change amount of sensing when the finger touch and do not touch the touch panel. The RC signal transmission time (RC Loading) of the horizontal coordinate indicates the time of transmitting a signal from the input to the touch location (away from the driving electrode lead 102, the resistance and capacitance are larger, and the RC Loading is larger). It can be seen from FIG. 7, when the screen is larger, according to the location gradually away from the signal input terminal, the change amount of the mutual capacitance gradually decreases, resulting in the sensitivity of the touch panel is inconsistent at different positions of the screen.

### SUMMARY OF THE INVENTION

The present invention provides a mutual capacitance touch panel, and the panel is for when the display screen is larger, it can increase the touching signal to noise ratio (SNR) and touching sensitivity.

To achieve the above objects, the present invention adopts the following technical solutions: a mutual capacitance touch panel, comprising:

a plurality of driving electrode strings arranged in parallel and along a horizontal direction, wherein, each of the driving electrode strings includes multiple driving electrodes connected in series, and each driving electrode connected with a driving electrode lead; and

a plurality of sensor electrode strings arranged in parallel and along a vertical direction, wherein, each of the sensor electrode strings includes multiple sensor electrodes connected in series, and each sensor electrode connected with a sensor electrode lead;

wherein, the driving electrodes and the sensor electrodes are located on a same plane, and on the whole touch panel, the driving electrodes and the sensor electrodes are distributed alternately with each other; between the adjacent driving electrode and the sensor electrode is provided with a fill pattern; wherein, all of the fill patterns along a same horizontal direction, widths of the fill patterns are decreased gradually in an arithmetic way according to a direction away from the driving electrode lead.

Wherein, all fill patterns along a same vertical direction, widths of the fill patterns are decreased gradually in an arithmetic way according to a direction away from the sensor electrode lead.

Wherein, the fill pattern includes a first fill pattern near a side of the driving electrode and a second fill pattern near a side of the sensor electrode, and the first fill pattern and the second fill pattern have the same widths.

Wherein, the widths of the first fill pattern and the second fill pattern are decreased from W1 to W2 according to the arithmetic way, wherein, a value range of W1 is 30˜40 μm, and a value range of W2 is 5˜10 μm.

Wherein a value of W1 is 30 μm and a value of W2 is 5 μm.

Wherein a value of W1 is 40 μm and a value of W2 is 10 μm.

Wherein, the driving electrode and the sensor electrode are all rhombus shapes; on the whole touch panel, the driving electrodes and the sensor electrodes are distributed alternately with each other; four sides of each of the driving electrodes are all correspondingly provided with the sensor electrodes; at the same time, four sides of each of the sensor electrodes are all correspondingly provided with the driving electrodes.

Wherein, the driving electrode, the sensor electrode, and the fill pattern are all transparent conductive materials and the transparent conductive material is indium tin oxide (ITO).

Another aspect of the present invention provides: a liquid crystal display (LCD) device, comprising an LCD panel and a backlight module; the LCD panel and the backlight module disposed oppositely; the backlight module providing a display light source for the LCD panel to make the LCD panel display an image, wherein, the LCD panel is the mutual capacitance touch panel described above.

Comparing the capacitive touch panel provided by present invention with the prior art. All fill patterns along a same horizontal direction, widths of the fill patterns are decreased gradually in an arithmetic way according to a direction away from the input signal. it can reduce the capacitance value of a location away from the signal input terminal so as to reduce the signal transmission time (RC Loading), improve the sensitivity of the touch panel; at the same time, through the arithmetic way, it also improve uniformity of the SNR at different locations in the touch panel.

### BRIEF DESCRIPTION OF THE DRAWINGS

FIG. 1 is a schematic diagram of operation principle of mutual capacitance touch panel; wherein, FIG. 1a is a schematic state diagram when the finger does not touch, FIG. 1b is a schematic state diagram when the finger touches.

FIG. 2 is a schematic structural diagram of touch structure layer in a capacitive touch panel in the prior art.

FIG. 3 is an enlarged schematic view of the portion A in FIG. 2.

FIG. 4 is a schematic structural diagram of touch structure layer in another capacitive touch panel in the prior art.

FIG. 5 is an enlarged schematic view of the portion B in FIG. 4.

FIG. 6 is a schematic diagram of operation principle of the touch panel shown in FIG. 4.

FIG. 7 the sensing variation at different locations according to the direction gradually away from the signal input terminal in the touch structure layer shown in FIG. 4.

FIG. 8 is a schematic structural diagram of a liquid crystal display device according to an embodiment of the present invention.

FIG. 9 is a schematic structural diagram of a capacitive touch panel according to an embodiment of the present invention.

FIG. 10 is a schematic structural diagram of touch structure layer in a capacitive touch panel according to an embodiment of the present invention.

FIG. 11 is an enlarged schematic view of the portion X1 in FIG. 10.

FIG. 12 the sensing variation at different locations according to the direction gradually away from the signal input terminal in the touch structure layer according to an embodiment of the present invention.

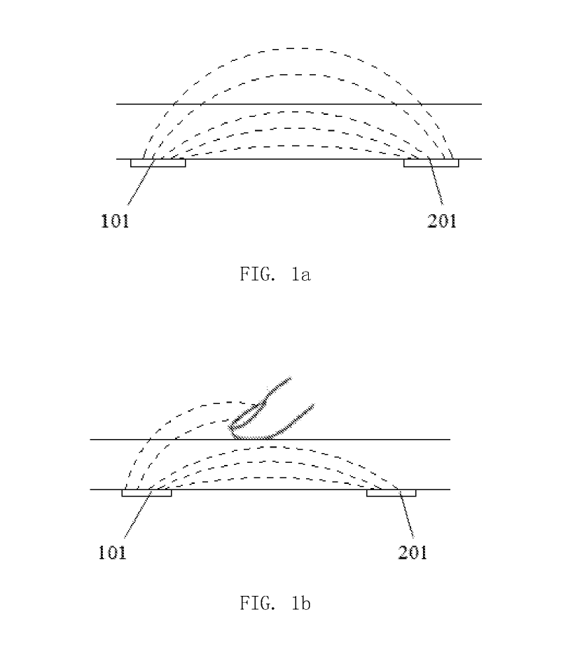

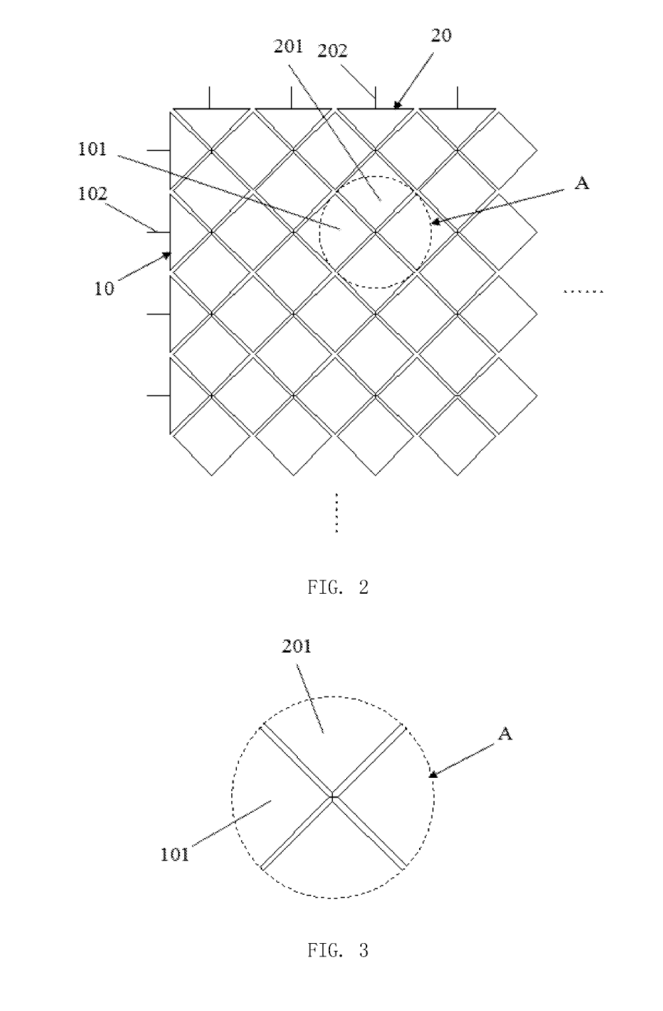

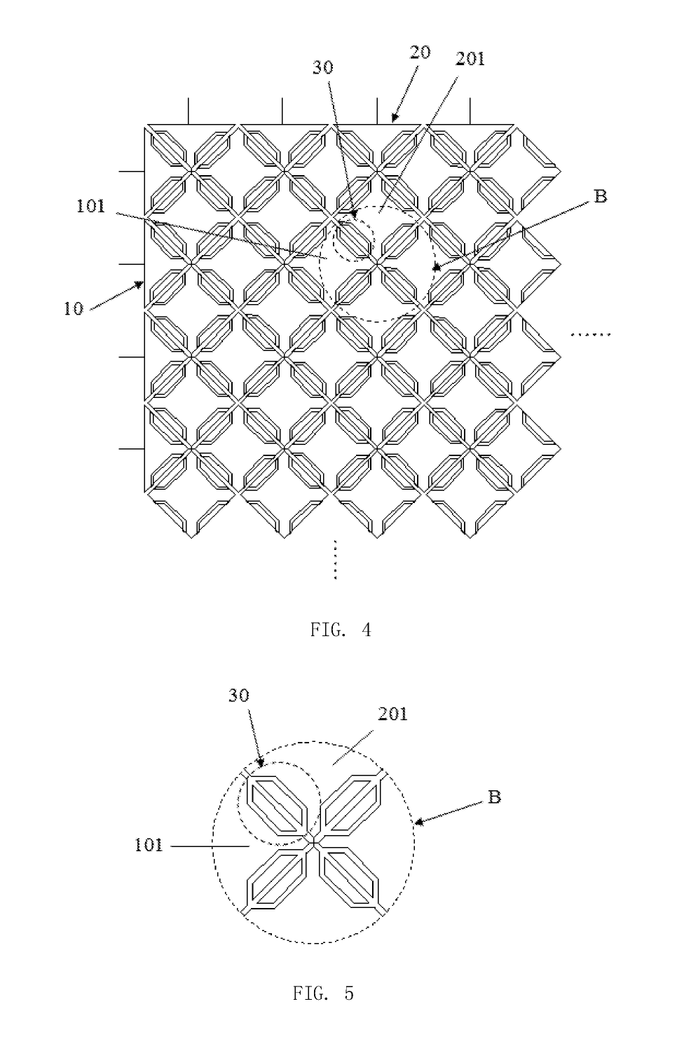

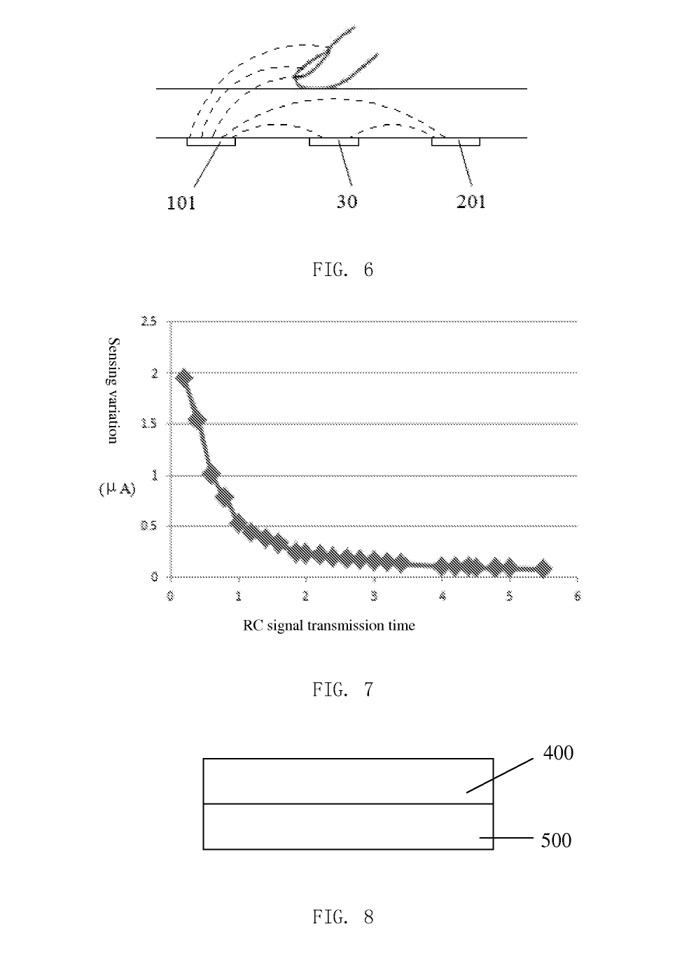

### DETAILED DESCRIPTION OF THE PREFERRED EMBODIMENT

As described above, the present invention is to provide a mutual capacitance touch panel and a liquid crystal display device comprising the touch panel with improvement in the signal to noise ratio (SNR) of the touch screen and the sensitivity of the touch panel. For all of the fill patterns in the same horizontal direction, according to the direction away from the input signal, widths of the fill patterns are gradually decreased according to an arithmetic way. Therefore, it can reduce the capacitance value of a location away from the signal input terminal so as to reduce the signal transmission time (RC Loading), improve the sensitivity of the touch panel; at the same time, through the arithmetic way, it also improve uniformity of the SNR at different locations in the touch panel.

The following content combines with the drawings and the embodiment for describing the present invention in detail.

As shown in FIG. 8, a liquid crystal display device provided by the present embodiment includes a liquid crystal display panel 400 and a backlight module 500, the liquid crystal display panel 400 and the backlight module 500 are disposed oppositely. The backlight module 500 provides the display light source for the liquid crystal display panel 400 such that the liquid crystal display panel 400 displays an image, wherein the liquid crystal display panel 400 is a mutual capacitance touch panel.

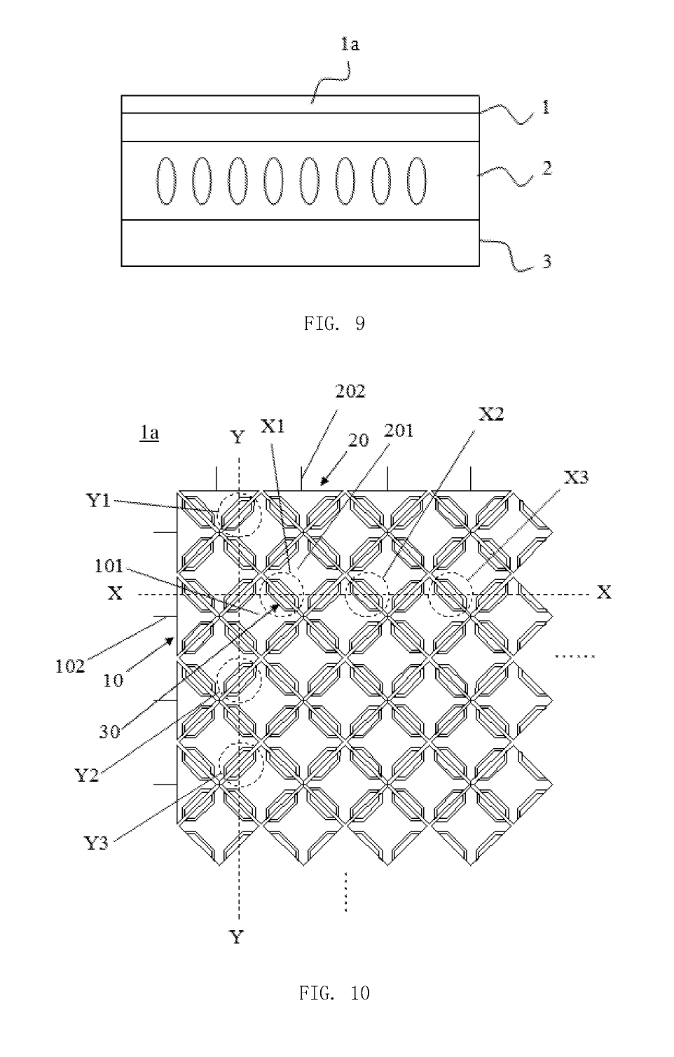

Specifically, the structure of the mutual capacitance touch panel is shown in FIG. 9. The mutual capacitance touch panel includes a pixel array substrate 3, a touch screen substrate 1 disposed oppositely to pixel array substrate 3, and a liquid crystal layer 2 disposed between the pixel array substrate 3 and the touch screen substrate 1, wherein touch screen substrate 1 comprises a touch structure layer 1a.

Furthermore, the touch structure layer 1a is shown in FIG. 10, the touch structure layer 1a includes a plurality of driving electrode strings 10 arranged in parallel and along a horizontal direction (a direction X-X as shown in FIG. 10) and a plurality of sensor electrode strings 20 arranged in parallel and along a vertical direction (a direction Y-Y as shown in FIG. 10). Each of the driving electrode strings 10 comprises multiple driving electrodes 101 connected in series. Each of the driving electrode strings 10 connects with a driving electrode lead 102. Each of the sensor electrode strings 20 comprises multiple sensor electrodes 201 connected in series. Each of the sensor electrode strings 20 connects with sensor electrode lead 202.

Wherein, the driving electrode 101 and the sensor electrode 201 are located on the same plane, and on the whole touch panel, the driving electrode 101 and the sensor electrode 201 are distributed alternately with each other. Between the adjacent driving electrode 101 and the sensor electrode 201, it provides with a fill pattern 30. The fill pattern 30 is isolated from the driving electrode 101 and the sensor electrode 201.

In this embodiment, the driving electrode 101 and the sensor electrode 201 are all rhombus shapes (the upper edges form a triangular shape), four sides of each of the driving electrodes 101 are all correspondingly provided with the sensor electrodes 201. Meanwhile, four sides of each of the sensor electrodes 201 are all correspondingly provided with the driving electrodes 101. Wherein, along the same horizontal direction (as the X-X direction shown in FIG. 10), all of the fill patterns 30 according to the direction away from the driving electrode lead 102, widths of the fill patterns 30 are decreased in an arithmetic way.

In the present embodiment, the widths of the fill patterns 30 are gradually decreased in the same horizontal direction, but the widths of the fill patterns 30 in the same vertical direction are the same. Specifically, with reference to FIG. 10, in the horizontal direction, from an order of X1-X2-X3 direction, the widths of the fill patterns 30 are gradually decreased, but in the same vertical direction of Y1, Y2, and Y3, the widths of the fill patterns 30 are constant. In another embodiment, it is not only that the widths of the fill patterns 30 are gradually decreased in the same horizontal direction, but also that the widths of the fill patterns 30 in the same vertical direction are decreased, and this way can achieve a better result.

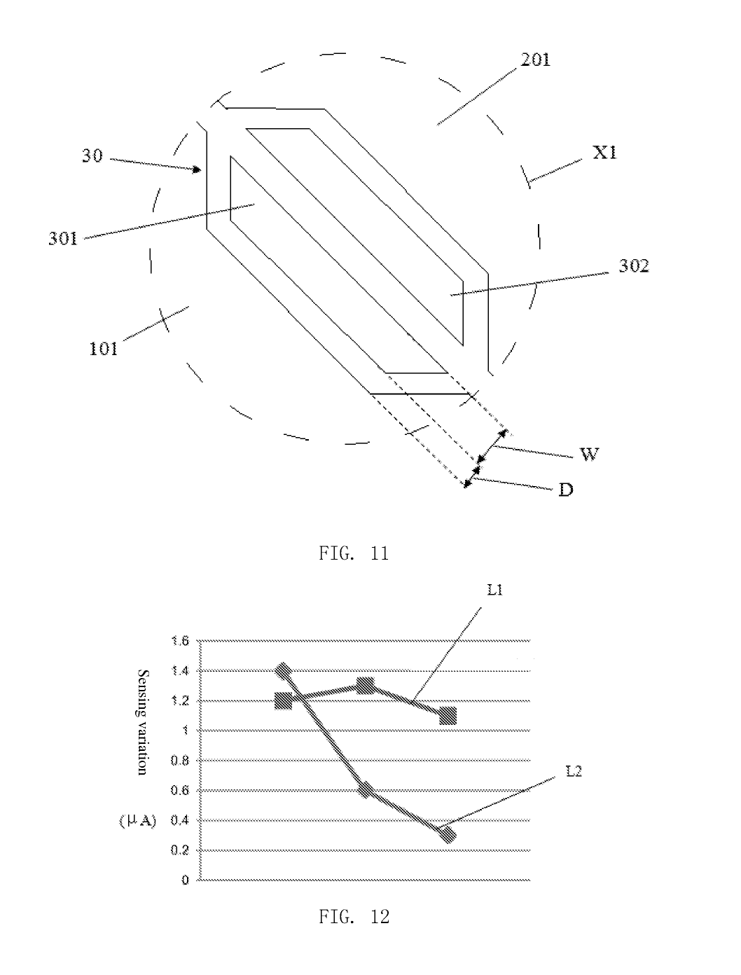

As shown in FIG. 11, in this embodiment, the fill pattern 30 comprises a first fill pattern 301 near a side of the driving electrode 101 and a second fill pattern 302 near a side of the sensor electrode 201. The first fill pattern 301 and the second fill pattern 302 have the same widths.

Wherein, the widths of the first fill pattern 301 and the second fill pattern 302 are decreased according to an arithmetic way from W1 to W2. In one embodiment, a value of W1 is 40 μm and a value of W2 is 10 μm. It should be noted that a value range of W1 may be selected to be 30˜40 μm, and a value range of W2 may be selected to be 5˜10 μm. Through verification, when a value of the W1 is 30 μm, and a value of the W2 is 5 μm, it can obtain the same effect as the present embodiment.

According to the direction which is away from signal input terminal (i.e., a terminal of the electrode lead), the widths of the fill patterns are gradually decreased in accordance with an arithmetic way. As shown in FIG. 11, because the widths W of the first fill pattern 301 and the second fill pattern 302 are continuously decreased, the distance D between the first fill pattern 301 and the driving electrode 101, and between the second fill pattern 302 and the sensor electrode 201 are increased so as to reduce the capacitances, that is, reducing the capacitance at the location away from the signal input terminal so as to reduce the signal transmission time (RC Loading), improve the sensitivity of the touch panel. At the same time, using the arithmetic way can make the signal to noise ratio (SNR) at different positions of the touch panel be uniform.

According to the above embodiments of the capacitive touch panel to perform testing for sensing variation when touches and does not touch at every locations of the touch panel, it obtains the curve diagram as shown in FIG. 12.

The sensing variation in the vertical coordinate indicates the change amount of sensing when the finger touches and does not touch the touch panel. The horizontal coordinate indicates different locations, wherein, the 0 point represents near the signal input terminal, and the increasing of the coordinate represent the touch location away from the signal input terminal. In FIG. 12, the curve L1 represents the capacitive touch panel provided by the present embodiment, and the curve L2 represents the capacitive touch panel provided by the prior art without changing the size of the fill patterns. From the curves in FIG. 12, comparing the capacitive touch panel provided by present invention with the prior art, the sensing variation is more uniform and the value is higher, which indicates that the capacitive touch panel provided by the present invention has uniform SNR and higher sensitivity.

In the present invention, the driving electrode 101, the sensor electrode 201, and fill pattern 30 are all transparent conductive material, and the transparent conductive material is ITO.

In summary, in the present invention, along the same horizontal direction, all of the fill patterns 30 according to the direction away from the input signal, widths of the fill patterns 30 are decreased in an arithmetic way. Therefore, it can reduce the capacitance away from the signal input terminal so as to reduce signal transmission time (RC Loading), to improve the sensitivity of the touch panel. Meanwhile, using the arithmetic way to decrease, it can improve uniformity of noise to signal ratio (SNR) at different locations in the touch panel.

It should be noted that, herein, the relational terms such as first and second, and the like are only used to distinguish one entity or operation from another entity or operation without necessarily requiring or implying that these entities or operations exist the actual relationship or order there between. Moreover, the terms “include”, “comprise”, or any other variation are intended to cover a non-exclusive inclusion, such that the process, method, article or device which include a series of elements are not only includes the process, method, article or device but also includes other elements which are not specifically listed or further include the inherent elements of such process, method, article or device. Without more constraints, by the statement “includes one . . . ” does not exclude the existence of additional identical elements in the process, the element, the method, article, or the apparatus.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A mutual capacitance touch panel, comprising:
a plurality of driving electrode strings arranged in parallel and along a horizontal direction, wherein, each of the driving electrode strings includes multiple driving electrodes connected in series, and each driving electrode connected with a driving electrode lead; and
a plurality of sensor electrode strings arranged in parallel and along a vertical direction, wherein, each of the sensor electrode strings includes multiple sensor electrodes connected in series, and each sensor electrode connected with a sensor electrode lead;
wherein, the driving electrodes and the sensor electrodes are located on a same plane, and on the whole touch panel, the driving electrodes and the sensor electrodes are distributed alternately with each other; between the adjacent driving electrode and the sensor electrode is provided with a fill pattern; wherein, all of the fill patterns along a same horizontal direction, widths of the fill patterns are decreased gradually in an arithmetic way according to a direction away from the driving electrode lead.

2. The mutual capacitance touch panel according to claim 1, wherein, all fill patterns along a same vertical direction, widths of the fill patterns are decreased gradually in an arithmetic way according to a direction away from the sensor electrode lead.

3. The mutual capacitance touch panel according to claim 1, wherein, the fill pattern includes a first fill pattern near a side of the driving electrode and a second fill pattern near a side of the sensor electrode, and the first fill pattern and the second fill pattern have the same widths.

4. The mutual capacitance touch panel according to claim 2, wherein, the fill pattern includes a first fill pattern near a side of the driving electrode and a second fill pattern near a side of the sensor electrode, and the first fill pattern and the second fill pattern have the same widths.

5. The mutual capacitance touch panel according to claim 3, wherein, the widths of the first fill pattern and the second fill pattern are decreased from W1 to W2 according to the arithmetic way, wherein, a value range of W1 is 30˜40 μm, and a value range of W2 is 5˜10 μm.

6. The mutual capacitance touch panel according to claim 4, wherein, the widths of the first fill pattern and the second fill pattern are decreased from W1 to W2 according to the arithmetic way, wherein, a value range of W1 is 30˜40 μm, and a value range of W2 is 5˜10 μm.

7. The mutual capacitance touch panel according to claim 5, wherein a value of W1 is 30 μm and a value of W2 is 5 μm.

8. The mutual capacitance touch panel according to claim 5, wherein a value of W1 is 40 μm and a value of W2 is 10 μm.

9. The mutual capacitance touch panel according to claim 5, wherein, the driving electrode and the sensor electrode are all rhombus shapes; on the whole touch panel, the driving electrodes and the sensor electrodes are distributed alternately with each other; four sides of each of the driving electrodes are all correspondingly provided with the sensor electrodes; at the same time, four sides of each of the sensor electrodes are all correspondingly provided with the driving electrodes.

10. The mutual capacitance touch panel according to claim 5, wherein, the driving electrode, the sensor electrode, and the fill pattern are all transparent conductive materials and the transparent conductive material is indium tin oxide (ITO).

11. A liquid crystal display (LCD) device, comprising an LCD panel and a backlight module; the LCD panel and the backlight module disposed oppositely; the backlight module providing a display light source for the LCD panel to make the LCD panel display an image, wherein, the LCD panel is a mutual capacitance touch panel, the mutual capacitance touch panel comprising:
a plurality of driving electrode strings arranged in parallel and along a horizontal direction, wherein, each of the driving electrode strings includes multiple driving electrodes connected in series, and each driving electrode connected with a driving electrode lead; and
a plurality of sensor electrode strings arranged in parallel and along a vertical direction, wherein, each of the sensor electrode strings includes multiple sensor electrodes connected in series, and each sensor electrode connected with a sensor electrode lead;
wherein, the driving electrodes and the sensor electrodes are located on a same plane, and on the whole touch panel, the driving electrodes and the sensor electrodes are distributed alternately with each other; between the adjacent driving electrode and the sensor electrode is provided with a fill pattern; wherein, all of the fill patterns along a same horizontal direction, widths of the fill patterns are decreased gradually in an arithmetic way according to a direction away from the driving electrode lead.

12. The LCD device according to claim 11, wherein, all of the fill patterns along a same vertical direction, widths of the fill patterns are decreased gradually in an arithmetic way according to a direction away from the sensor electrode lead.

13. The LCD device according to claim 11, wherein, the fill pattern includes a first fill pattern near a side of the driving electrode and a second fill pattern near a side of the sensor electrode, and the first fill pattern and the second fill pattern have the same widths.

14. The LCD device according to claim 12, the fill pattern includes a first fill pattern near a side of the driving electrode and a second fill pattern near a side of the sensor electrode, and the first fill pattern and the second fill pattern have the same widths.

15. The LCD device according to claim 13, wherein, the widths of the first fill pattern and the second fill pattern are decreased from W1 to W2 according to the arithmetic way, wherein, a value range of W1 is 30˜40 μm, and a value range of W2 is 5˜10 μm.

16. The LCD device according to claim 14, wherein, the widths of the first fill pattern and the second fill pattern are decreased from W1 to W2 according to the arithmetic way, wherein, a value range of W1 is 30˜40 μm, and a value range of W2 is 5˜10 μm.

17. The LCD device according to claim 15, wherein, a value of W1 is 30 μm and a value of W2 is 5 μm.

18. The LCD device according to claim 15, wherein, a value of W1 is 40 μm and a value of W2 is 10 μm.

19. The LCD device according to claim 15, wherein, the driving electrode and the sensor electrode are all rhombus shapes; on the whole touch panel, the driving electrodes and the sensor electrodes are distributed alternately with each other; four sides of each of the driving electrodes are all correspondingly provided with the sensor electrodes; at the same time, four sides of each of the sensor electrodes are all correspondingly provided with the driving electrodes.

20. The LCD device according to claim 15, wherein, the driving electrode, the sensor electrode, and the fill pattern are all transparent conductive materials and the transparent conductive material is indium tin oxide (ITO).
